(19) United States
(12) Patent Application Publication
(10) Pub. No.: US 2011/0241503 A1
(43) Pub. Date: Oct. 6, 2011

(54) DECORATIVE COMMERCIAL OR PROFESSIONAL KITCHEN OR FOOD SERVICE AREA APPLIANCE UNIT WITH INTERCHANGEABLE FORM FITTING COVER AND A FACADE PANEL

(76) Inventor: Lee Simon, Tampa, FL (US)

(21) Appl. No.: 13/150,587

(22) Filed: Jun. 1, 2011

Related U.S. Application Data
(63) Continuation-in-part of application No. 10/534,550, filed on May 9, 2005, now abandoned.

(51) Int. Cl. F16B 12/00; F24C 15/06; A47L 15/42; A21B 1/00; E03C 1/00; F25D 23/00; B23P 17/04

(52) U.S. Cl. 312/111; 29/428

(57) ABSTRACT

A line of kitchen and/or food service-type appliances that have decorative covers that are interchangeable. Each interchangeable cover may be a form fitting cover or a façade panel. The appliance units may be modified to change their appearance with interchangeable decorative covers, such that interchangeability and modification are made quick, easy and affordable. Preferably, the appliances are within their own modular reconfigurable appliance receptacle having an array of connectors to accommodate to hold a plurality of different appliance units. Each receptacle has a frame for holding various appliance units in different spatial configuration, generally horizontal and vertical, and connectors to quickly connect and/or disconnect the appliance units to the type of power utility necessary, such as gas for a stove, and electricity for a microwave oven. The appliance units are removably attached within the frame, and are interchangeable such that they are configurable as desired and may be removed for repair or replacement, with ease. To add to the configurablity of the receptacle, the frame permits one or more appliance units in both vertical and horizontal spaces within and on the frame.

### REFERENCE TO COPENDING PATENT APPLICATIONS

This application is a continuation-in-part of U.S. patent application Ser. No. 10/534,550 filed May 9, 2005, which in turn is a national stage entry of PCT/USO4/00639 filed Jan. 12, 2004, which in turn claims the benefit of priority from provisional patent application Ser. No. 60/439,347 filed Jan. 10, 2003.

### FIELD OF THE INVENTION

The present invention concerns a line of kitchen and/or food service-type appliances whose decorative cover may be interchanged. The interchangeable cover may be a form fitting cover or a façade panel. Each appliance may be a generally vertically oriented appliance, such as an oven, and/or a generally horizontally oriented appliance, such as a stove-top. The different kinds of appliances may be, but need not be, interchangeable, respective to orientation, within the frame.

### BACKGROUND OF THE INVENTION

Current ranges and other appliances do not offer flexibility. That is, when an oven is installed, the location where the installation took place will generally always be used to accommodate an oven as opposed to some other appliance, absent a major overhaul of the kitchen and/or food service area. Indeed, if the color scheme or theme of the kitchen and/or food service area changes, one is stuck with the way existing appliances are decorated as the factory installed look for the appliances. If one wants a different factory installed look for the appliances to match an updated color scheme or theme of the kitchen and/or food service area where existing appliances area located, then entirely new appliances may need to be acquired as replacements for the existing appliances to match, blend or otherwise complement the desired color scheme or theme. The existing appliances generally are discarded as a complete loss.

Generally all conventional appliances have a similar limitation, that is that once selected the appliance may only be used for its primary task and decorative appearance with little possibility for modification, advancement or change of task or style. Some of the known specific disadvantages of existing appliances, and specifically kitchen and foodservice area related equipment include:

Standardization of Models. Presently, manufacturers of appliances offer their wares as standardized models. These units are not always designed to meet the needs of the end user. Rather, the end user is often forced to adapt his or her appliance needs to the equipment that is available, perhaps resulting in an undesirable operational or functional compromise.

Limited Modifications. Modifications to the current equipment are labor intensive, if they are even possible. Such modifications include, among others, changing a stove from a four to a five burner system, or replacing burners with a griddle or grill feature, among others. These modifications require service-authorized technicians to perform modifications and the “end work” must usually be done in the field or the entire unit must be shipped back to the factory. Any such modification or remanufacturing generally result in higher costs for the food preparation industry.

Cost of Modifications. The modifications that may currently be made to “standard equipment” generally require re-evaluation by the various approval agencies (such as UL, ETL, NSF and others). Such re-evaluation may significantly increases the cost of customizing equipment, as well as lead time for production, and may reduce the viability of making any such alterations required or desired by the end user.

Maintenance and Repair. The original unit, once set in place, is often difficult to remove and/or access as such units are generally built into cabinets or onto wall units. As a result, most service calls are executed in the field. Service calls in the field are typically expensive and are often inefficient, as all parts are typically not carried by service personnel, or initial diagnosis of a problem may be incorrect requiring more extensive repairs than first thought. Additionally, if a piece of equipment fails, the entire unit must usually be repaired or replaced in its entirety. As is known, by persons having skill in the art, the cost of repairs in the field may be significantly higher than at the factory or at a local, centralized service agency. Further, on-site service is typically one of a manufacturer's largest variables or unknown costs.

Upgrades and Expandability. Similar to modifications, upgrades and expansions of appliances are typically difficult and costly, if possible and available. Once again, an authorized service technician would typically be required to make a service visit at considerable cost and time.

Repetitive Inventory. Because most currently available units are manufactured as a single or unitary piece, additional and costly inventory is often required by manufacturers and distributors in order to keep products available for purchase and for replacement parts. For example, an existing equipment format might require that two six-burner ranges be stocked, one with a standard oven base and one with a convection oven base.

Multiple Formats. Current equipment components utilize a variety of footprints and configurations. This variety increases the production and development costs of a line of products. Because some kitchen and/or food service areas require appliances with a smaller footprint than others, in order for a manufacturer (or a distributor) to accommodate customers necessitating different size appliances, the manufacturer (or distributor) must stock units of all sizes and footprints, consuming storage and display space.

Established Utility Connections. Current equipment supplies and availabilities are based around specific utility formats such as voltage and phase. A change in the voltage or phase of a piece of equipment typically requires the services of an authorized service technician, which as noted above, may be costly.

It is therefore desirable to provide a cooking line, both for commercial and domestic usage, that is designed to keep up with the growing requirements of the evolving food and beverage industry and/or the needs of the modern home.

### BRIEF SUMMARY OF THE INVENTION

One aspect of my invention pertains to interchangeable covers are provided for appliance, with each interchangeable cover being a form fitting cover or a façade panel. They are preferably removable and replaceable with other covers for the same appliance. That way, an entire set of appliances in a kitchen or food service area may have their interchangeable covers replaced to suit the needs for a common color scheme or theme for the kitchen or food service area, i.e., the decorative look of the interchangeable covers may match, complement or purposely contrast such a common color scheme or theme as desired.

Generic interchangeable covers, sized and configured for the required size and orientation of the vacant slot, enable flexibility to add appliances when convenient, and not necessarily at the time of initial purchase. That is, the purchaser may acquire appliances from different manufacturers at different times or even the same manufacturers at subsequent times, without being concerned that the color scheme of the appliance interchangeable covers do not all match. This is because of set of matching interchangeable covers in accordance with the invention may be procured at any time to replace the original interchangeable covers for the appliances.

Another aspect of my invention pertains to a modular appliance receptacle that eliminates most of the above noted problems while accommodating numerous cooking and kitchen and/or food service preparation appliances and products. Advantageously, the inventive modular appliance receptacle is: user friendly, convenient, economical, easy to manufacture, durable and effective.

The appliance receptacle may be provided to accommodate the appliance and may be modular and reconfigurable to accommodate one or more appliance units. The appliance receptacle has a frame for holding at least one of the appliance units and comprises a connector for connecting one or more appliance units to utilities as needed. For example, the frame may have connection points, in standard positions, for electricity, gas, water and universal connection ports, such as described hereafter.

The appliance receptacle may be sold with appliance units removably attached within or alone, such that at least one of the plurality of appliance units available may be operatively and removably attached within the frame. Further the attached appliance unit may be, when desired, operatively and removably replaced. Indeed, the appliances may or may not be interchangeable with another of the plurality of appliance units.

The modular reconfigurable appliance receptacle has a frame having at least one first bay for insertion of at least one generally vertically oriented unit and at least one second bay for placement of at least one generally horizontally oriented unit. In this preferred embodiment, at least one connector and preferably an array series or set of connectors that provide a connector assembly for operably connecting units to utilities as needed are included, such that either a gas, electric, water or steam appliance may be installed in the frame with equal ease. The frame permits one or more of a plurality of interchangeable appliance units to be removably placed, attached or secured into either the first or second bay, as needed. Removable guides may sub-divide the top into 1, 2 or 3 sections. Further, one or more units may be interchanged with another similarly oriented unit when repair or exchange is need or desired.

The kitchen or food service area appliance units, as that term applies in connection with the present invention, include generally oven-shaped units, generally stove-top shaped units, sinks, dish washers and refrigeration units. For example, the oven-shaped units may be traditional gas or electric ovens, convection ovens, warming drawers, or microwave ovens. The stove-top shaped units may be grills, burners or griddle units, both gas powered and/or electric or steamers, additionally utilizing water or steam connections. The refrigeration units may be wine chillers or ice machines. Where the kitchen or food service area appliance unit is refrigeration unit, it may exist in an upright, undercounter, walk-in, or equipment stand configuration. The decorative covers of the present invention may be removably secured to any of these kinds of kitchen or food service area appliance units.

The frame of the modular reconfigurable appliance receptacle may be constructed to hold a plurality of the plurality of appliance units. For example, two appliance units are may be held, one in a generally horizontal configuration and another in a generally vertical configuration. Further, the frame may be constructed to hold more than two appliance units or to accommodate fractional units, such as one-half convection oven and one-half microwave oven in the same frame, or one-half burner stove top and one half griddle stove top. The fractional units may be interchangeable among a number of such units.

As an example, which is not intended to be limiting, it will be seen that in one frame unit, an owner (or the manufacturer or distributor) may place a microwave oven and a convection oven, either side by side or one atop the other, in a vertical-oriented opening, and two burners, a griddle and a grill unit in a horizontal-oriented opening. The user can, at some time, remove the microwave oven and the convection oven and replace them with one or more replacement units; for example, both may be replaced with one conventional gas oven. The modular frame may also be used without each potential receptacle location being occupied.

The burners, griddle and grill may be replaced, as desired, with a single unit of six burners, which could be gas or electric, notwithstanding the power source of the original three units. One or more gas units and one or more electrical units may be used simultaneously in each opening, vertically or horizontally oriented, without departing from the novel scope of the present invention. In this way, should it be desired, a gas oven, an electric microwave, a set of gas burners and an electric griddle could all be used in the same frame.

One or more of the appliances, based on the utility requirements of that particular appliance, may attach to and utilize more than one utility type simultaneously. That is to say, a particular appliance, for example, may require both water and electricity and shall have the capacity to connect and utilize both utility formats simultaneously. Further, in a separate embodiment a generally vertical receptacle is provided such that a plurality of generally vertically shaped appliances may be installed. For example, a microwave oven, a conventional oven and a convection oven may be installed in such a frame, and later interchanged with other similarly shaped appliances, as needed or desired.

A more detailed explanation of the invention is provided in the following description and claims and is illustrated in the accompanying drawings.

### BRIEF DESCRIPTION OF THE DRAWINGS

FIG. 1 is a perspective view of a frame of the present invention in accordance with principles of the present invention.

FIG. 2 is a side elevational view of the frame of FIG. 1.

FIG. 3 is a plan view of a utility chassis, with various utility connections, for use with the device of the present invention.

FIG. 4 is a cross-sectional view of the utility chassis of FIG. 3, taken along the plane of line 4-4 of FIG. 3.

FIG. 5A is a front elevational view of a modular appliance constructed in accordance with the principles of the present invention.

FIG. 5B is a front elevational view of another modular appliance constructed in accordance with the principles of the present invention.

FIG. 5C is a front elevational view of a further modular appliance constructed in accordance with the principles of the present invention.

FIG. 6A is a front elevational view of an upright modular appliance constructed in accordance with the principles of the present invention.

FIG. 6B is a front elevational view of another upright modular appliance constructed in accordance with the principles of the present invention.

FIG. 6C is a front elevational view of another upright modular appliance constructed in accordance with the principles of the present invention.

### DETAILED DESCRIPTION OF THE INVENTION

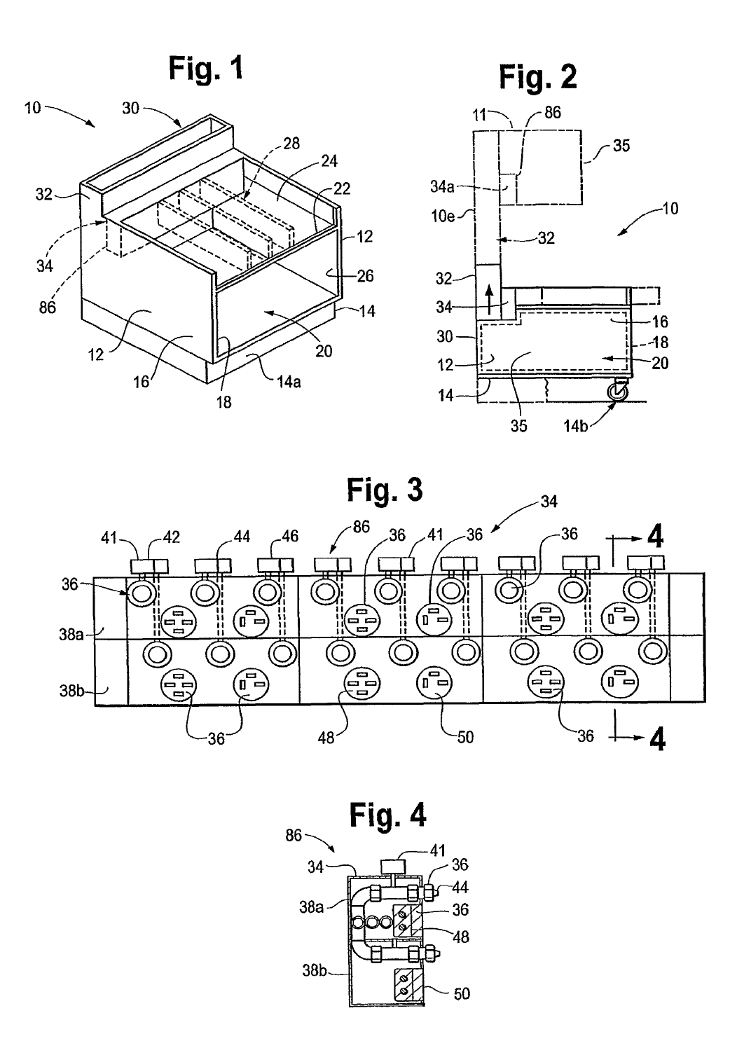

As shown in FIGS. 1 and 2, a modular reconfigurable appliance receptacle includes a frame 10 having sidewalls 12 and a bottom 14. The bottom 14 may be formed as a solid base 14a (FIG. 1), or may include legs or casters 14b (FIG. 2). If casters 14b are used, the whole frame 10 may be wheeled from one location to another.

The frame 10 forms an enclosure 16 with a front opening 18. The interior or cavity 20 of the frame 10, in a first embodiment, may be partitioned by a generally planar or flat horizontal divider 22 into bays such as an upper portion 24 (first bay) and a lower portion 26 (second bay). The upper portion 24 may be further subdivided by upright vertical adapters 28. The back of the enclosure 30 may be formed with a universal flue riser 32. The universal flue riser 32 may be configured so as to provide a smoke and gas discharge as needed.

Further, as shown in FIGS. 1 and 2, enclosure or back 30 may provide and define a utility chassis 34. Utility chassis 34 provides access to power and gas utilities as well as steam and water connections for the various accessories or appliances 35 forming the cooking line, as explained in greater detail below. As shown in more detail in FIGS. 3 and 4, the utility chassis 34 may provide a plurality of sockets 36 of various types. More particularly, at regular intervals along the length of the chassis 34, there may be provided clusters 38 of sockets 36. Preferably, each cluster 38 includes a top portion 38a and a bottom portion 38b. Each cluster portion 38a, 38b could, in the illustrated embodiment, include identical sets 40 of sockets 36. Preferably, each socket 36 is of a quick-connect type socket 36, as is known in the art, ready to accept a matching plug from an accessory, as described in greater detail below.

More specifically, a cluster portion 38a, 38b, in specific embodiments, may include one or more of the following types of sockets 36; gas 42, hot water 44, cold water 46, high voltage (480 vac) 48, and low voltage (120/208 vac) 50 as well as other sockets 36 for new or other utilities as they are developed and incorporated into appliances 35 and houses. New utilities, such as computer or Internet based and other communication based utilities may be utilized in food preparation and processes and therefore utilities related thereto may be incorporated in the present invention without departing from the scope thereof.

The position of each socket 36 within each cluster portion 38a and 38b, may be preferably identical. In this way, each appliance 35 may be made in a standard format to ease the interchangeability of appliances 35 in an appliance 35 line. However, modification, such as changes in position may be accommodated such as with conversion units without departing from the novel spirit and scope of the present invention. Additionally, each cluster 36 may be provided with required safety devices such as shut-off valves or electrical breakers (not shown) and quick disconnect devices for gas, water and electricity and others. Each of such safety and quick release devices may be adapted to close anyone or more of the respective utility and may be of types which are well known in the art. The shut-off valves may be arranged to shut off the utility for each portion independently, or may be arranged to shut off the utility for both portions of a cluster. Additional sockets 36 for other services may be incorporated into the chassis 34, such as vacuum, air, etc. The supply for all of the services is provided to a common location may be located either in the back or the side of the frame.

Referring now to FIG. 3 some examples of well known quick-connect type electrical and plumbing connectors 42 are shown. In the embodiments shown, the top and bottom cluster portions 38a and 38b (FIG. 3) are identical, however, in other embodiments, these cluster portions may be different, as necessary for the particular appliance 35 or type of appliance 35. As previously discussed, the frame 10 has a modular design and may be constructed in either standard size, or several standard sizes, such as in increments of 6, 12 or 3 inches to accept accessories and/or appliances 35 of corresponding widths. Because the cavity 20 (FIG. 1) within the frame 10 is partitioned into an upper 28 and a lower 26 portion, each portion 26, 28 may be used to accommodate a different appliance 35 and/or accessory. Importantly, the upper portions 44a of each utility portions 44 are arranged and constructed to accept and mate with the plugs 46 of a corresponding appliance 35. More specifically, one appliance 35 may be inserted into the bottom portion 20a of the cavity through opening 18 and another appliance 35 may be inserted into the top portion 20b or compartment. Each appliance 35 (FIG. 2) may be constructed, in a convenient place and to correspond with a modular connection system, with its own plug 46 (FIG. 3) so that once the appliance 35 is inserted into the frame 10, it is automatically connected to the sockets 36 within the respective cluster portion.

Accessories and appliances 35 for the cooking line are sized, constructed and arranged to fit into either the upper or lower portion of the frame interior, with connectors formed on their back surface. The accessories and appliances 35 may then be installed by sliding them laterally into the respective interior portion until the quick connectors on their back surface couple or mate with the respect sockets 36 of the utility chassis 34. In this manner, as soon as an accessory or appliance 35 is introduced into the frame, it is automatically connected to the respective utility lines that it requires and it is ready for use.

As shown in FIGS. 1 and 2, a universal flue riser 32 may be provided in the back of the frame. Riser 32 may be connected to a flue riser or other ventilation connection in a manner known to persons having skill in the art. Riser 32 permits any appliance device 35 that requires venting, such as certain types of ovens, having for example broiler means, and cook top grills, to be vented through an exhaust duct and out of the kitchen and/or food service area and building. Additionally, as shown by the broken lines in FIG. 2, the frame 10 may be provided with an extension 10e that may support a secondary appliance holding space 11. Space 11 may be provided with its own utility chassis 34a, as required, and may accommodate additional accessories and appliances 35 that may be installed in the same manner as the accessories and appliances 35 in the main frame interior.

As will be understood by persons having ordinary skill in the art, some accessories and appliances 35 may require additional connections. For example, a sink may require a drain. These additional connections may be provided through the back wall of the frame, either before, or after the accessory or appliance has been installed.

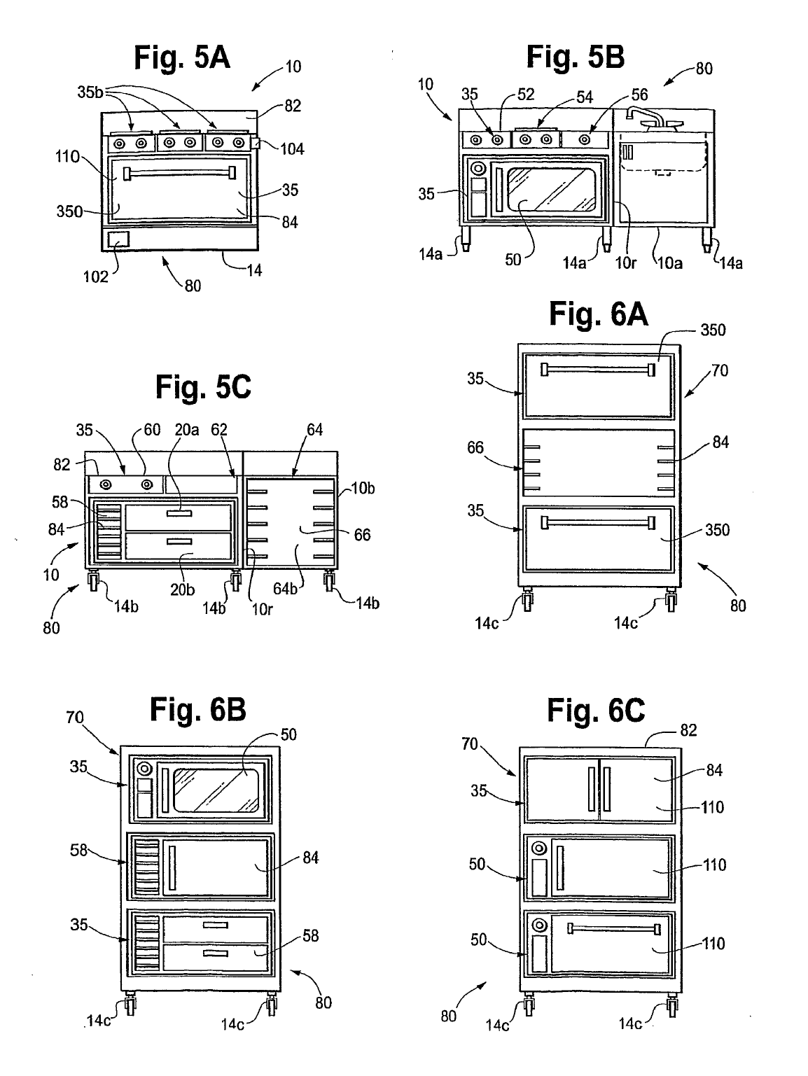

Referring to FIGS. 5A-5C, a number of combinations of appliances 35 are shown, as examples. In FIG. 5A, the frame 10 accommodates a 36-inch oven 35a in its lower portion 26 and three double gas burner 35b units in the upper portion 24. As previously discussed, frames 10 may be provided in various, preferably modular, lengths as needed. However, two or more frames 10 may also be positioned side-by-side; further, in such units the utility chasses 34 may be interconnected in a manner known by persons having skill in the art.

Referring now to FIG. 5B, it may be seen that one frame 10 may be made to hold a gas or a microwave oven 50 in the lower portion 26, a radial fin 52, a double gas burner 54 and an induction heating unit 56 in the upper portion 24. An auxiliary frame 10a may be attached to the right side 1 Or of the frame 10 and may be constructed and arranged to include a sink 58 in the upper portion 24. The frames 10, 10a are provided with legs 14a for a base. The configuration shown is only illustrative of the almost innumerable combinations that are contemplated in the present invention.

Referring now to FIG. 5C, it will be see that frame 10 is mounted on wheels or casters 14b. In FIG. 5C a refrigerator 58 is placed in the lower portion 26, and a charbroiler 60 and a hot top 62 in the upper portion 24. Further, an auxiliary frame 10b is mounted on the right side 10r of frame 10, to provide a work surface 64 with cantilevered brackets that promote pan sliders 66 to receive trays or pans in the interior compartment or chamber 64b. The configuration shown is only illustrative.

In several of the preferred embodiments, as described, a rectangular or box-like frame 10 has been noted. Referring now to FIGS. 6A-68C, an upright or vertical frame 70 may be provided to create appliances and appliance combinations utilizing free vertical space in a kitchen and/or food service area. A vertical utility chassis is not shown but similar in design to the utility chasses shown in FIGS. 5B and 5C.

A universal frame 80 (FIGS. 6A-6C), that is either the originally described frame 10 or the vertical frame 70, may be designed and constructed to accept a number of different cooking surfaces 82 and cavity accessories 84. Frame 80 may feature solid construction using either welding or bolting, or any manner of joining structural elements to form a solidly constructed frame, as known by persons having ordinary skill in the art, featuring the level of quality desired by the consumer or required by code or other governmental, consumer, approval (such as UL, ASTM or others.) or manufacturing group guidelines. All types of structural materials, including, but not limited to steel, iron, aluminum, alloys of metal, wood, plastics, rubber and other materials having desirable characteristics, such as strength, ease of manipulation and construction as well as and flexibility, may be used in the manufacture of the frames and other elements of the receptacles without departing from the novel scope of the present invention.

The required utility infrastructure, provided as part of the frame 80 itself, may be manufactured, in a manner well known in the art, so as to distribute the required utilities throughout the frame 80. Interlocking connectors of the type known in the art may securely and removably fasten the range frames 80 and utility infrastructure components together in desired and desirable configurations.

The frames 80 (FIGS. 6A-6C) may be installed either on casters 14b, for mobility and easy cleaning, or on a structural base 14, for more permanent installations. Where used, the structural base 14 will eliminate the need for a separate concrete curb, as often required by code or manufacturer. Each such frame 80 may be pre-drilled to accept either casters or a base configuration.

Appliance components inserted to comprise the cooking surface of an appliance combination may vary in function and size. The cooking surface of the frame may be designed to accept one (1), two (2) or three (3) components, depending on the size and design of the individual component. For example, the 36″ cooking surface may accept three (3) 12″ modules or two (2) 18″ modules, or one (1) 36″ griddle top.

In an alternate embodiment, to add or remove one of the cooking surface accessories, a release 102, 104 (as explained below) is depressed and the accessory may be released from secure attachment to the surface. For gas units, a gas quick-disconnect valve 41 (FIG. 3) may be depressed, releasing the accessory from the range. In the case of electrical cooking surfaces, the unit will be unplugged, releasing the accessory from the range. Once the accessory is removed, it may be replaced with a different component or standardized flat panel, which will serve as a work surface.

Similar to the cooking surface, the cavity 20 (FIG. 1) of the modular reconfigurable appliance receptacle may include the same type of quick release feature 100 for gas, water, and electric components. A mechanical button 102 (FIG. 5A) on the front face of a range 35 may activate the release. Thus, the cavity components 35 may be removed for repair or replacement with ease.

Both the cooking surface and cavity gas connections may have a gas quick disconnect 104 (FIG. 5A) with such means as a ball valve that prevents gas from leaking from the plumbing fixtures, and other means known to persons having skill in the art. It is well known that a ball valve works by allowing gas to flow when the unit is properly connected and stopping such flow when disconnected. When the unit is removed, gas will not be able to flow, so as to provide safety from gas release in a manner known to persons having ordinary skill in the art.

As previously discussed, a full-height frame 70 (FIGS. 6A-6C) may also be constructed so as to accept two (2) appliance components 35, one in the lower cavity and one in the upper cavity of the full-height frame. This allows the end user additional flexibility to create equipment pieces, through the use of available accessories and components, that will best suit the end users needs.

The units are provided with interchangeable covers 110 (FIGS. 5A and 6C) such that a user may determine a specific look for the appliance units, such as to provide a specific theme in a kitchen or food service area. In a specific example, should a particular color or material, such as stainless steel or enameled steel, or the like, be desired, particular form fitting covers, of a type similar to those used with modern cellular telephones and/or replaceable façade panels, may be placed onto the appliance units. Each form fitting cover or replaceable façade panels will have the desired specific look so as to match or complement the color scheme or specific theme in the kitchen or food service area. Alternatively, one might choose interchangeable covers whose appearance contrast or even clash with such a color scheme or specific theme.

The replaceable façade panels may be configured for installation in any desired one of a variety of ways including, snap fittings, by use of fasteners (such as screws), magnetics, adhesives and hook and eye fasteners (such as that sold under the brand name VELCRO). Preferably, the replaceable façade panels are formed to wrap around or sandwich supporting portions of the appliance frame and secure to itself and yet retained in position by the appliance frame. Otherwise, the replaceable façade panels and the appliance frame may have complementary snap fittings or mechanical fasteners or be adhered to each other.

The ability to change the appearance of appliance units permits the user to modify existing sets of appliances of the present invention, without purchasing new units. For instance, if the type of appliance(s) previously purchased are still necessary for a particular food service setting and a refreshing of a style or mode is desired, an inexpensive but dramatic change may be made simply by replacing the interchangeable covers on the appliances in accordance with the invention. Further, as restaurants and homes move for more dramatic decors in their respective food service areas, the present invention permits the user to decorate in these areas in ways previously unavailable.

The interchangeable cover may be of stainless steel material and incorporate any one or plurality of a variety of finish materials such as bonded metal, glass, laminate, plastic, steel, which may be commercially available and incorporated into the decorative interchangeable cover of the present invention.

Access to the utilities already provided through the utility distribution system will allow for both simple and sophisticated decorative adapters ranging in shape, size, color, material, etc. Such sophisticated adapters could include lights, moving parts, and other such integral features that may be desired to integrate with or otherwise enhance the adjacent decor. Such decorative adaptors may be adjacent or neighboring the appliances in close proximity to instill their effect. For instance, if the decorative adaptors are lights, perhaps colored lights, they would be aimed to shine onto the appliance interchangeable covers.

Among the many advantages of the inventive, modular, reconfigurable appliance and cooking line of commercial and/or domestic food service equipment are the following:

Flexibility: The end user will have unprecedented flexibility to customize his or her cooking equipment, either during the initial order or in the field. The possible combinations will be endless. This feature will also reduce the cost of upkeep, upgrades, and menu changes by the operator.

Variable Size: The use of frames in the different available sizes will allow the creation of a customizable range in various increments, such as established increments, such as 3 or 6 or 12-inch increments. While units in inches are given, herein, standard units in either imperial or metric denominations could be used without departing from the novel scope of the present invention.

Variable Installation Methods: The same range frame may be installed on casters or a structural base. The end user will specify at the time of ordering which is desired. Both installation methods, however, will be based on the same means of securing the appliance within the frame and the utilities to the appliance.

Plug and Play Capability: Much like a computer system, the frame will accept standardized components for the cooking surface or the cavity, as the end-user needs them. If desired, a customer could order a frame and three (3) two-burner tops, leaving the cavity component as a future purchase. As a result, the equipment meets the needs of the end-user, not the other way around.

End User Buy-in: The end user would be investing in a system, and not just one, freestanding piece of equipment. This could certainly have a positive effect on sales. Incremental sales, or the purchase of additional component, are also more likely and could increase potential revenue.

Longer Life, Lower Cost: Because of the format and flexibility, the life cycle cost associated with this product will be lower than the average range line. If an accessory is no longer operational or desirable, the end-user may replace the accessory, keeping the frame and other accessories in tact. This extends the usable life, and lowers the cost of future replacements.

Maintenance and Repair: The costs of service may be significantly reduced, while simultaneously minimizing customer inconvenience. With modular accessories, the individual component may be removed for servicing. Replacement components may be kept in stock by local service agencies and loaned to the end-user to minimize downtime. The defective or non-working accessory may then be serviced at the local service agent's facility, or sent to a central repair facility operated by the manufacturer. In either event, the number of field service agent hours, and the subsequent costs, may both be reduced.

Cleaning and Maintenance: Removable components make routine cleaning and maintenance easier, because the operator may readily access the parts of the component that require attention. As is understood by users of prior art equipment, maintenance, including servicing and cleaning, on hard-to-access areas in prior art equipment is rarely conducted.

Simplified Manufacturing: The manufacturing process would be simplified. The frames would all be of a standard format, while the accessories would be smaller components that require less time to produce and are easier to handle. Additionally, the “integration” of these components would no longer have to be done in the factory. Rather, assembly of the frame and accessories could be done anywhere (i.e. field, dealer, etc.).

Further, the present invention may also have the following benefits:

Reduction in Cost of Research and Development: Because the format will be universal amongst the cooking surface and cavity components, the cost to develop new components will be reduce. The new items will be designed around a universal format and may utilize the same manufacturing equipment.

Reduced Cavity Component Cost: Because the frame will serve as the structural element, the individual components do not need to replicate this structural integrity for the range. The components may also rely on the structure of the range for support with locking and/or supporting mechanisms. The result is a reduction of materials and cost for these components.

Universal Approvals: Modifications and customization of current products typically require the manufacturer to re-submit the altered product to the required approval agencies (i.e. UL, ETL, NSF, etc.). The manufacturer, by receiving an approval for the commercial cooling line as a single system, and all of its available components, would significantly reduce the cost of this flexibility. No additional approvals should be required to make the numerous available changes possible with this commercial cooking line.

Reduction of Inventory: The inventory required to support field sales would be significantly reduced. The manufacturer would no longer have to stock a six-burner range with a standard oven and a six-burner range with a convection oven. Rather, an order should be filled, such as by pulling a 36″ frame, three (3) 12″ burner sections, and either a convection oven or standard base. Depending on the situation, this modification could be done at the factory, at the dealership, or at the final destination, provided the dealership has all the required parts.

Lower Distribution Costs: Because the accessories will be smaller in size and modular, the units will be easier to ship via readily accessible carriers (i.e. UPS, Federal Express, etc.). A “budget series” six-burner range, for example, may be shipped in with a knocked down frame, three (3) 12″ burner sections and a cabinet or oven base . . . depending on the configuration the end-user has ordered.

Future Compatibility: The utilities and standardized component configurations enable the range frame to accept accessories, even perhaps those that have not yet been developed. Forward compatibility is invaluable to the food and beverage industry.

Non-Cooking Accessories: Non-cooking accessories, such as customized shelves, rails, etc., may be provided. Sharing of the dimensions and configuration of this universal platform would further entrench the brand and product in the marketplace.

Decorative Features: The current emphasis on display kitchen and/or food service areas and for cooking within the view of ones guests, at a restaurant or at home, requires that the cooking equipment's aesthetics be given more attention. The plug and play format may include decorative, customizable interchangeable covers. The end-user and design team will have the capability to further incorporate the cooking equipment into the interior design of the space. These decorative adapters, similar to modern cell phone cover plates, which permit the customization of cell telephones, may be provided as mechanical (requiring utilities to support a specific feature) or non-mechanical. The modular system and access to utilities provide an opportunity for incorporating both sophisticated and simple decorative adapters.

An important and innovative aspect of reconfigurable appliance receptacle of the present invention is its flexibility in creating a collection of appliances or a cooking appliance that fits the needs of the user. The changes to appliances made possible by the present invention are not only in the physical changes to the way appliances are made and configured but also a philosophical change that will clearly result in numerous different positive outcomes for the end-user, manufacturer, and distributor alike. With the proper manufacturing, marketing, and support, this commercial and domestic cooking line may change the cooking appliance industry.

The changes possible to appliances include, removably-interchangeable cooking surfaces; removably-interchangeable cavity components; removably-interchangeable decorative finishes; provision of frames with pre-piped, pre-wired, and pre-plumbed utility infrastructure pre-prepared to accept available components; as well as various range or stove-top format that are expandable in the field.

Although illustrative embodiments of the invention have been shown and described, it is to be understood that various modifications and substitution, as well as other appliances, equipment, devices, and connectors, may be made by those skilled in the art without departing from the novel spirit and scope of the invention.

What is claimed is:

1. A decorative unit, comprising a commercial or professional kitchen or food service area appliance unit; an interchangeable cover removably attached to the kitchen or food service area appliance unit, the interchangeable cover being selected from the group consisting of a form fitting cover and a façade panel, and means for removably attaching said interchangeable cover to the kitchen or food service area appliance unit.

2. The decorative unit of claim 1, wherein the interchangeable cover is of a material selected from the group consisting of stainless steel and enameled steel.

3. The decorative unit of claim 1, wherein the interchangeable cover is of stainless steel material and incorporates any one or plurality of a variety of finish materials, the finish materials being selected from the group consisting of bonded metal, glass, laminate, plastic, and steel.

4. The decorative unit of claim 1, wherein the means for removably attaching being selected from the group consisting of snap fittings, screw fasteners, magnetics, adhesives and hook and eye fasteners.

5. The decorative unit of claim 1, further comprising a frame with at least one bay, the kitchen or food service area appliance unit being contained in the at least one bay.

6. The decorative unit of claim 5, wherein the frame makes provision for utility connection to the kitchen or food service area appliance unit.

7. The decorative unit of claim 5, wherein the frame has an additional bay, further comprising an additional kitchen or food service area appliance unit contained in the additional bay; and additional interchangeable cover that is removably attached to the additional kitchen or food service area appliance unit, the additional interchangeable cover being selected from the group consisting of a form fitting cover and a façade panel.

8. The decorative unit of claim 7, wherein the bays are arranged in a vertical manner of one over the other, the frame being self-standing.

9. The decorative unit of claim 1, wherein the kitchen or food service area appliance unit is selected from the group consisting of a burner unit, a griddle unit, a ventilation unit, and a warming unit.

10. The decorative unit of claim 1 wherein the kitchen or food service area appliance unit is selected from the group consisting of a gas oven, an electrical oven, a convection oven, a microwave oven, a dish washer, a sink, and a warming drawer unit.

11. The decorative unit of claim 1, wherein the kitchen or food service area appliance unit is a refrigeration unit and has a configuration selected from a group consisting of an upright, an undercounter, a walk-in, and an equipment stand.

12. The method of claim 1, wherein the interchangeable cover is a form fitting cover.

13. The method of claim 1, wherein the interchangeable cover is a façade panel.

14. A method of providing a decorative unit, comprising removably attaching an interchangeable cover to a kitchen or food service area appliance unit, and selecting the interchangeable cover from the group consisting of a form fitting cover and a façade panel.

15. The method of claim 14, wherein the selecting includes selecting material of the interchangeable cover from the group consisting of stainless steel and enameled steel.

16. The method of claim 14, wherein the interchangeable cover is of stainless steel material and incorporates any one or plurality of a variety of finish materials, and selecting the finish materials from the group consisting of bonded metal, glass, laminate, plastic, and steel.

17. The method of claim 14, wherein the removably attaching is carried out with items selected from the group consisting of snap fittings, screw fasteners, magnetics, adhesives and hook and eye fasteners.

18. The method of claim 14, further comprising containing the kitchen or food service area appliance unit in at least one bay of a frame.

19. The method of claim 18, wherein the frame makes provision for utility connection to the kitchen or food service area appliance unit.

20. The method of claim 18, wherein the frame has an additional bay, further comprising containing an additional kitchen or food service area appliance unit in the additional bay; and removably attaching additional interchangeable cover to the additional kitchen or food service area appliance unit, and selecting the additional interchangeable cover from the group consisting of a form fitting cover and a façade panel.

21. The method of claim 18, wherein the frame is self-standing and defines a plurality of bays arranged in a vertical manner of one over the other, containing the kitchen or food service area appliance unit in at least one of the plurality of bays of the frame.

22. The method of claim 14, wherein the kitchen or food service area appliance unit is selected from the group consisting of a burner unit, a griddle unit, a ventilation unit, and a warming unit.

23. The method of claim 14, wherein the kitchen or food service area appliance unit is selected from the group consisting of a gas oven, an electrical oven, a convection oven, a microwave oven, a sink, a dish washer, and a warming drawer unit.

24. The method of claim 14, wherein the kitchen or food service area appliance unit is a refrigeration unit and has a configuration selected from a group consisting of an upright, an undercounter, a walk-in, and an equipment stand.

25. The method of claim 14, wherein the interchangeable cover is a form fitting cover.

26. The method of claim 14, wherein the interchangeable cover is a façade panel.
